(19) United States
(12) Patent Application Publication
(10) Pub. No.: US 2022/0121454 A1
(43) Pub. Date: Apr. 21, 2022

(54) CONFIGURATION DEVICE

(71) Applicant: Hewlett-Packard Development Company, L.P., Spring, TX (US)

(72) Inventors: Kyle James Nottingham, Boise, ID (US); Matthew Frederickson, Spring, TX (US); Gerold Keith Shelton, Boise, ID (US)

(73) Assignee: Hewlett-Packard Development Company, L.P., Spring, TX (US)

(21) Appl. No.: 17/418,274

(22) PCT Filed: Apr. 15, 2019
(86) PCT No.: PCT/US2019/027461

§ 371 Date: Jun. 25, 2021

(51) Int. Cl. G06F 9/445; G06F 9/4401; G06F 13/38; G06F 13/40; G06F 1/26

(52) U.S. Cl. CPC G06F 9/4451; G06F 9/4411; G06F 1/266; G06F 13/409; G06F 13/382

(57) ABSTRACT

An example configuration device can include a connection cable to be coupled to a port of a device positioned within a device package, wherein the connection cable is to provide electrical power to the device positioned within the device package and provide communication between the configuration device and the device positioned within the device package, and a computing device comprising instructions to: activate the device positioned within the device package through the connection cable, format the device positioned within the device package through the connection cable, and deactivate the device positioned within the device package through the connection cable.

### BACKGROUND

A computing device can include devices that utilize a processing resource to execute instructions to perform particular functions. For example, a computing device, such as a laptop computer or desktop computer can include a central processing unit (CPU) to execute instructions for an operating system to perform particular functions. In some examples, the computing device can be configured to execute instructions in a particular way.

### BRIEF DESCRIPTION OF THE DRAWINGS

FIG. 1 is an example system for a configuration device consistent with the present disclosure.

FIG. 2 is an example system for a configuration device consistent with the present disclosure.

FIG. 3 is an example system for a configuration device consistent with the present disclosure.

FIG. 4 is an example system for a configuration device consistent with the present disclosure.

FIG. 5 is an example package gate consistent with the present disclosure.

FIG. 6 is an example package gate consistent with the present disclosure.

FIG. 7 is an example package gate consistent with the present disclosure.

### DETAILED DESCRIPTION

Devices, such as computing devices, can be manufactured by a manufacturer to a particular specification (e.g., particular operating system, particular set of settings, particular applications installed, etc.). In some examples, an intermediate user can be utilized by an end user or organization to configure the devices to a particular state. In some examples, the intermediate user can remove the device from the device packaging provided by the manufacturer to configure the device. For example, the intermediate user can receive a packaged device from a manufacturer. In this example, the intermediate user can remove the device from the device packaging and connect the device to a power source and/or configuration device. These examples can be relatively costly to the intermediate user and possibly introduce human error when the intermediate user repackages the device.

The present disclosure relates to systems and devices for configuring a device within the device packaging. For example, the present disclosure includes device packaging that allows access to a number of ports of the device such that a configuration device can be coupled to the number of ports. In this way, the device and/or accessories of the device can remain within the device packaging while the device is being configured for an end user. In some examples, the device packaging can include an aperture for a package gate to allow access to a channel that is coupled to a particular port. In these examples, the configuration device can be coupled to the device while the device is within the device packaging. In this way, the device packaging can remain intact while the device is being configured.

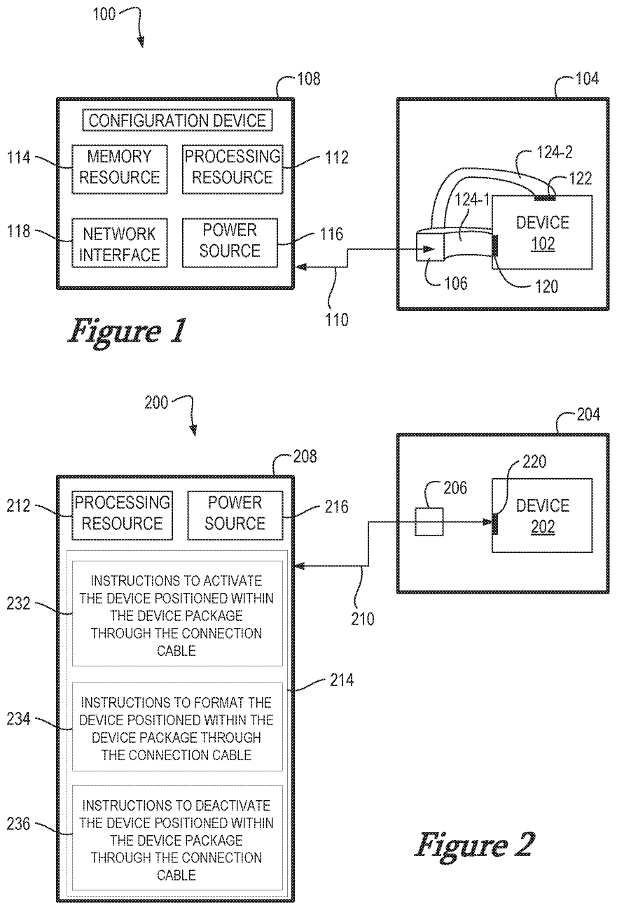

FIG. 1 is an example system 100 for configuring a device 102 consistent with the present disclosure. The system 100 can include a configuration device 108 that includes a memory resource 114, a processing resource 112, a network interface 118, and/or a power source 116. A configuration device 108, as used herein includes a device (e.g., physical device) used for configuring a device 102 positioned within device packaging 104. In some examples, the system 100 can include a device 102 packaged within a device package 104 that includes packaging material (e.g., packing peanuts, paper material, foam, etc.).

As used herein, device packaging can include shipping and/or storage packaging to enclose and protect the device 102 for transporting the device 102 from a manufacturer to an end user. As described herein, configuring a device 102 can include configuring the hardware, BIOS, drivers, software instructions, and/or OS of the device 102, among other components or instructions of the device 102. The configuration device 108 can be a combination of hardware and instructions for configuring a device 102 positioned within the device packaging 104. The hardware, for example can include processing resource 112, power source 116, network interface 118, and/or a memory resource 114 (e.g., machine readable medium (MRM), computer-readable medium (CRM), data store, etc.).

Processing resource 112, as used herein, can include a number of processing resources capable of executing instructions stored by a memory resource 114. The instructions (e.g., machine-readable instructions (MRI)) can include instructions stored on the memory resource 114 and executable by the processing resource 112 to implement a desired function (e.g., configuring a device 102, altering settings of the device 102, etc.). The memory resource 114, as used herein, can include a number of memory components capable of storing non-transitory instructions that can be executed by processing resource 112. Memory resource 114 can be integrated in a single device or distributed across multiple devices. Further, memory resource 114 can be fully or partially integrated in the same device as processing resource 112 or it can be separate but accessible to that device and processing resource 112. Thus, it is noted that the configuration device 108 can be implemented on an electronic device and/or a collection of electronic devices, among other possibilities.

In some examples, the configuration device 108 can be utilized to configure a device 102 within a device packaging 104. For example, the configuration device 108 can configure the device 102 by transferring end user configuration information (e.g., image, applications, settings, etc.) to the device 102 while the device is positioned within the device packaging 104. In some examples, the configuration device 108 can be physically coupled to the device 102 through a connection cable 110 that is coupled to the configuration device 108 at a first end and coupled to the device 102 at a second end.

In some examples, the connection cable 110 can be extended from the configuration device 108, through a port channel 124-1, to a port 120 of the device 102. In some examples, the port channel 124-1 can be an area of removed packaging material within the device package 104. In other examples, the port channel 124-1 can be a tubular structure that creates a barrier between the packaging material of the device package 104 and the port channel 124-1. In some examples, the port channel 124-1 can extend from the port 120 of the device 102 to the package gate 106. In some examples, the package gate 106 can be utilized to create an aperture within the device package to expose the port channel 124-1 that an provide physical access to the port 120. In some examples, the package gate 106 can be positioned in a designated area positioned on an exterior of the device package 104 to receive the package gate 106.

In some examples, the port 120 can be utilized to: communicate with the configuration device 108, provide power to the device 102, and/or provide a network connection to the device 102. For example, the configuration device 108 can utilize the processing resource 112 and the memory resource 114 to configure settings of the device 102 through the connection cable 110 coupled to the port 120. In another example, the configuration device 108 can provide power to the device 102 utilizing the power source 116. In this example, the configuration device 108 can provide power to the device 102 through the connection cable 110 coupled to the port 120.

Furthermore, in some examples, the configuration device 108 can utilize the network interface 118 to provide a network connection for the device 102. In this example, the configuration device 108 can utilize the connection cable 110 coupled to the port 120 of the device 102 to provide the network connection utilizing the network interface 118 through the connection cable 110. In some examples, the network connection, provided through the configuration device 108, can be connected to a secured network connection with an end user of the device 102. In this way, the end user or an administrator for the end user can access the device 102 through the network connection provided through the connection cable 110. In this way, the end user or the administrator can configure the device 102 from a remote location while the device 102 is positioned within the device package 104.

In some examples, the configuration device 108 can communicate with the device 102, provide power to the device 102, and/or provide a network connection to the device 102 through the connection cable. In some examples, the connection cable can be a universal serial bus type C (USB-C) type connection cable that call allow for communication transfer, power transfer, and/or network transfer simultaneously. In this way, a single port 120 can be utilized to configure the device 102 when the device 102 is positioned within the device package 104.

In some examples, the device 102 can be a computing device such as a laptop, tablet, smartphone, or desktop computer, among other types of computing devices. In some examples, the device 102 can utilize a vent 122 to remove relatively warm air from components within the device 102. For example, the vent 122 can be a heat vent that can be utilized to remove heat from the components such that the device 102 does not overheat while operating. As described herein, the configuration device 108 can be utilized to activate or turn on the device 102 through the connection cable 110. In addition, the configuration device 108 can utilize the power source 116 to provide electrical energy to the device 102. In some examples, the device 102 can include a cooling system that utilizes components to remove heat from the device 102 while the device 102 is activated. For example, the device 102 can include a fan to move air toward a vent 122 to remove the relatively warm air from an interior of the device 102. In this example, the fan and vent 122 can be utilized to cool the components within the device 102.

In some examples, the device package 104 can include packaging material that can surround the device 102 to protect the device 102 during shipping. In some examples, the device package 104 can include a ventilation channel 124-2 to allow the relatively warm air from the vent 122 to be removed from the device package 104 to allow the cooling system of the device 102 to operate while the configuration device 108 configures the device 102. In some examples, the ventilation channel 124-2 can be positioned from the vent 122 of the device 102 to an exterior portion of the device package 104 to allow a flow of air from the vent 122 to the exterior portion of the device package 104 (e.g., package gate, aperture, etc.).

In some examples, the ventilation channel 124-2 can be positioned between a vent 122 of the device 102 and the exterior of the device package 104. In these examples, the ventilation channel 124-2 can be an area of removed packaging material and/or a tubular structure as described further herein. In some examples, the ventilation channel 124-2 can be coupled to a portion of the port channel 124-1. For example, the ventilation channel 124-2 can be coupled to a portion of the port channel 124-1 between the port 120 of the device 102 and the package gate 106. In some examples, the ventilation channel 124-2 and the port channel 124-1 can both be coupled to the package gate 106. In some examples, the ventilation channel 124-2 can be structurally similar to the port channel 124-1. For example, the ventilation channel 124-2 can be a portion of the device package that is void of packaging material and/or the ventilation channel 124-2 can be a tubular structure that can prevent packaging material from entering the ventilation channel 124-2. Thus, in some examples, the port channel 124-1 can include a ventilation channel 124-2 for the device within the device package 104. In some examples, the ventilation channel 124-2 can include a path of removed packaging material between an air vent 122 of the device 102 and the designated area of the package gate 106. In some examples, the ventilation channel 124-2 can connect to a unique package gate (e.g., package gate 106, package gate other than package gate 106, etc.), allowing the entry or escape of the heated air.

Thus, the system 100 can be utilized to configure a device 102 within the device packaging 104 (e.g., manufacturer packaging, etc). In this way, the system 100 can allow an intermediate customer to configure the device 102 without having to remove the device from the original packaging (e.g., device packaging 104). This can be relatively less expensive for the intermediate customer since the intermediate customer will not have to completely remove the device 102 from the device packaging 104 and then replace the device 102 within the device packaging 104 before sending the device 102 to the end user.

FIG. 2 is an example system 200 for configuring a device consistent with the present disclosure. In some examples, system 200 can include similar elements as system 100 as referenced in FIG. 1. For example, system 200 can include a configuration device 208 that includes a processing resource 212, a power source 216, and a memory resource 214 storing instructions 232, 234, 236. In addition, system 200 can include a device 202 positioned within a device package 204.

As described herein, the configuration device 208 can be coupled to the device 202 through a connection cable 210 that is coupled to a port 220. In some examples, the connection cable 210 can extend through a package gate 206 or aperture within the device package 204. In some examples, the system 200 can include a connection cable 210 to be coupled to a port 220 of a device 202 positioned within a device package 204. In these examples, the connection cable 210 is to provide electrical power to the device 202 positioned within the device package 204 and provide communication between the configuration device 208 and the device 202 positioned within the device package 204.

In some examples, the port 220 of the device 202 positioned within the device packaging 204 is the only port accessible to an exterior position of the device package 204. As described herein, the port 220 can be accessible to the exterior position of the device package 204 through the package gate 206 and/or the port channel. However, in these examples, the other ports of the device 202 can be covered by packaging material within the device package 204. In this way, the other ports of the device 202 can be non-accessible without removing the device 202 from the device package 204.

Processing resource 212, as used herein, can include a number of processing resources capable of executing instructions stored by a memory resource 214. The instructions (e.g., machine-readable instructions (MRI)) can include instructions stored on the memory resource 214 and executable by the processing resource 212 to implement a desired function (e.g., providing power to a device 202, configuring a device 202, and/or providing a network connection to a device 202, etc.). The memory resource 214, as used herein, can include a number of memory components capable of storing non-transitory instructions that can be executed by processing resource 212.

The memory resource 214 can be in communication with the processing resource 212 via a communication link (e.g., path). The communication link can be local or remote to an electronic device associated with the processing resource 212. The memory resource 214 includes instructions 232, 234, 236. The memory resource 214 can include more or fewer instructions than illustrated to perform the various functions described herein. In some examples, instructions (e.g., software, firmware, etc.) 232, 234, 236 can be downloaded and stored in memory resource 214 (e.g., MRM) as well as a hard-wired program (e.g., logic), among other possibilities.

Instructions 232, when executed by a processing resource such as processing resource 212 can activate the device 202 positioned within the device package 204 through the connection cable 210. As used herein, activating the device 202 includes providing electrical power to the device 202 and turning on the device 202 to a state that allows settings to be altered. For example, activating the device 202 can include providing power to the device 202 through the connection cable 210 with the power source 216. In this example, activating the device 202 can also include starting the device 202 such that the device enters a pre-operating system mode (e.g., mode that allows the device 202 to alter settings without starting the operating system, etc.).

In some examples, the electrical power can be provided to the device 202 through the connection cable 210 via the power source 216 and the activation instructions can be sent to the device 202 through the connection cable 210. As described herein, the device 202 can receive the electrical power from the power source 216 and the activation instructions through the port 220. In some examples, the port 220 can be a USB type port such as a USB-C port. In this way, the electrical power and instructions can be provided through the same port 220. In this way, a single connection cable 210 can be utilized to provide electrical power and instructions to the device 202.

Instructions 234, when executed by a processing resource such as processing resource 212 can format the device 202 positioned within the device package 204 through the connection cable 210. In some examples, formatting the device 202 can include configuring the device 202 with a particular device image and/or device setting. As used herein, a device image can be a digital representation of the operating system, data files, applications, and/or other features of the device 202. For example, formatting the device 202 can include the configuration device 208 installing a device image on the device 202 that corresponds to an end user of the device 202. In this example, the device image can include drivers, applications, and/or setting changes for the device 202 that are specific to the end user of the device 202.

In some examples, the instructions to format the device 202 include instructions to alter configuration settings of the device 202 based on an end user of the device positioned within the device package 204. For example, the end user may request particular configuration settings for the device 202. In this example, the configuration device 208 can alter the configuration of the device 202 with the requested configuration settings when the device 202 is going to be provided to the end user. In some examples, the device image or format of the device 202 can be based on a profile of the end user. For example, the profile of the end user can be an employment profile for the end user that can be provided by the employer or related organization. In this example, the user profile can indicate a particular level of employment at the employer and the employer may want particular settings and/or permissions configured to the device 202 for the particular end user. In this way, the configuration device 208 can provide the particular settings to the device 202 while the device 202 is positioned within the device package 204.

In some examples, the configuration device 208 can include a computing device (e.g., a combination of the processing resource 212 and the memory resource 214, etc.) that can execute the instructions 232, 234, 236 to perform the functions described herein. In some examples, the memory resource 214 can be utilized to store format settings for a plurality of different devices and to apply a corresponding format setting to the device 202 within the device packaging 204 based on an identification of the device 202 within the device packaging. As described herein, the device 202 can include an identification number (e.g., serial number, etc.) that can correspond to a specific user. In some examples, the memory resource 214 can store format settings for a plurality of devices that can be installed on a corresponding device based on the identification of the device.

In some examples, the configuration device 208 can include a plurality of connection cables to couple to a plurality of different devices (e.g., computing devices, etc.) positioned within corresponding device packages simultaneously. For examples, the configuration device 208 can include a plurality of connection cables and utilize the plurality of format settings to apply a corresponding format setting to a corresponding device based on the identification of the corresponding device. In some examples, the plurality of devices can be coupled to the configuration device 208 and the format settings can be applied to the plurality of devices positioned within corresponding device packages simultaneously or substantially simultaneously.

In some examples, the plurality of devices can be provided a secure network connection and a remote computing device can apply format settings to the plurality of devices simultaneously or substantially simultaneously. In some examples, the plurality of connection cables can be utilized to provide a secure network connection to each of the plurality of devices within corresponding device packages. For example, the configuration device 208 can provide a secure network connection to a plurality of different devices within corresponding device packages such that a remote device or a plurality of remote devices can configure the plurality of devices simultaneously or substantially simultaneously through the secure network connection provided by the configuration device 208.

Instructions 236, when executed by a processing resource such as processing resource 212 can deactivate the device 202 positioned within the device package 204 through the connection cable 210. As described herein, the device 202 can be configured by the configuration device 208 while the device 202 is positioned within the device package 204. In addition, the configuration device 208 can deactivate the device 202 positioned within the device package 204 such that the device 202 begins a new user tutorial when the device 202 is activated by the end user. In this way, the end user can go through the new user tutorial for the device 202 even though it was previously activated by the configuration device 208.

In some examples, deactivating the device 202 can include sending a signal or message to the device 202 to shut down with a shut down process associated with the device 202. In some examples, deactivating the device 202 can include preventing electrical power from being transferred to the device 202 through the connection cable 210. Once the device 202 is deactivated by the configuration device 208, the connection cable 210 can be removed from the device package 204 and the package gate 206 can be closed and locked as described further herein.

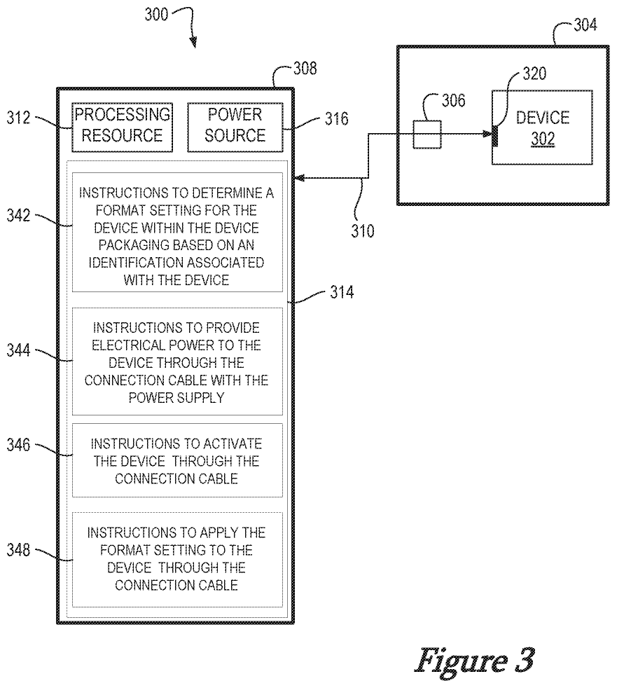

FIG. 3 is an example system 300 for configuring a device 302 consistent with the present disclosure. In some examples, system 300 can include similar elements as system 200 as referenced in FIG. 2, and/or system 100 as referenced in FIG. 1. For example, system 300 can include a configuration device 308 that includes a processing resource 312, a power source 316, and a memory resource 314 storing instructions 342, 344, 346, 348. In addition, system 300 can include a device 302 positioned within a device package 304. As described herein, the configuration device 308 can be coupled to the device 302 through a connection cable 310 that is coupled to a port 320. In some examples, the connection cable 310 can extend through a package gate 306 or aperture within the device package 304.

Instructions 342, when executed by a processing resource such as processing resource 312 can determine a format setting for the device 302 within the device packaging based on an identification associated with the device. As used herein, a format setting of the device 302 can be a setting alteration and/or image alteration for the device 302. In some examples, the setting alteration can include changing a number of settings of the device 302. For example, the setting alteration can include altering access permissions for particular applications, adding a plurality of certificates that correspond to a particular end user, and/or adding a plurality of applications that are specific to the particular end user. In some examples, an organization corresponding to the end user can provide the format setting for the device 302.

In some examples, the format setting for the device 302 can be based on a device type for the device 302. For example, a particular type of device that is to be provided to an organization can have a corresponding format setting to be installed. For example, the organization can distribute different types of devices to different end users. In this example, the configuration device 308 can include instructions to determine the device type of the device 302 and determine the format setting for the device 302 based on the determined device type. In some examples, an organization can purchase a specific device for each of a plurality of end users that each utilize a corresponding format setting. In these examples, the configuration device 308 can include instructions to determine a device identification for the device 302 and determine the format setting for the device 302 based on the device identification of the device 302.

Instructions 344, when executed by a processing resource such as processing resource 312 can provide electrical power to the device 302 through the connection cable 310 with the power supply (e.g., power source 316, etc.). As described herein, the configuration device 308 can include a power source 316 that can provide electrical power to the device 302. In some examples, the power source 316 can be separate from a power source or power supply that provides electrical power to the configuration device 308. For example, the configuration device 308 can include a first power source to provide power to the configuration device 308 and a second power source to provide power to the device 302.

In some examples, the configuration device 308 can determine a device type of the device 302 to determine a quantity or type of electrical power to be provided to the device 302. For example, a plurality of electrical devices can utilize different voltage, current, or type of current (e.g., direct current, alternating current, etc.) of electrical power. In this example, the configuration device 308 can utilize the device type to determine the properties of the electrical power that the device 302 utilizes and provide the electrical power with the determined properties through the connection cable 310.

Instructions 346, when executed by a processing resource such as processing resource 312 can activate the device 302 through the connection cable 310. As described herein, activating the device 302 includes providing electrical power to the device 302 and turning on the device 302 to a state that allows settings to be altered, formatting to be performed, and/or an image to be installed. For example, activating the device 302 can include starting the device 302 such that the device 302 enters a pre-operating system mode (e.g., mode that allows the device 302 to alter settings without starting the operating system, etc.).

In some examples, activating the device 302 can include bringing the state of the device 302 to a point that is capable of receiving the format setting or performing the format setting. For example, activating the device 302 can include activating a memory resource of the device 302 such that the format setting can be executed on the memory resource of the device 302. In some examples, a portion of the device 302 can be activated while other portions of the device 302 remain deactivated. For example, a BIOS of the device 302 can be activated to execute the format settings on the device 302 while an OS of the device 302 remains deactivated.

In some examples, the instructions 346 to activate the device 302 include instructions to activate a configuration mode of the device 302 to enable the device 302 to receive the format setting. As used herein, a configuration mode of the device 302 can include a pre-operating system mode that allows a memory resource of the device 302 to receive or install the format setting. In some examples, the configuration mode of the device 302 can include a mode that does not initiate the operating system of the device 302 but provides access to configuring the device 302.

Instructions 348, when executed by a processing resource such as processing resource 312 can apply the format setting to the device 302 through the connection cable 310. In some examples, the instructions to apply the format setting to the device 302 can include instructions or messages provided to the device 302 that can be received by the port 320 of the device 302 through the connection cable 310. In some examples, the configuration device 308 can send the format settings to the device 302 through the connection cable 110 and the device 302 can execute the format settings provided by the configuration device 308. In other examples, the configuration device 308 can be utilized to install the format settings on the device 302 through the connection cable 310 without the device 302 having to execute the instructions.

In some examples, applying the format setting to the device 302 can include applying or installing a device image to the device 302. For example, the configuration device 308 can install a device image in a drive of a memory resource of the device 302. In this example, the configuration device 308 can install the device image such that when an end user activates the device 302, the device image is activated and executed by the device 302.

In some examples, applying the format setting to the device 302 can include applying the format setting to a drive of the device. As used herein, a drive of the device can be a separate memory resource and/or partition of a memory resource. In some examples, the drive of the device that has the format setting applied can be a separate memory resource or separate partition from a location where the operating system is stored. For example, the device 302 can include a first memory resource partition that is utilized to store an operating system, data files, among other types of files. In this example, the device 302 can include a second memory resource partition that is utilized to store a device image. In this example, the format setting to the device 302 can be applied to the second memory resource partition.

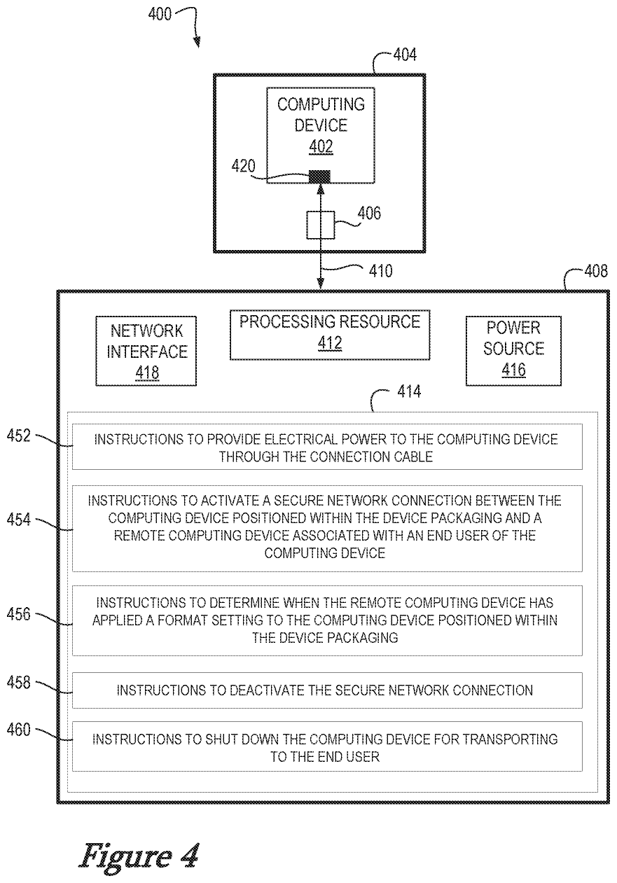

FIG. 4 is an example system 400 for configuring a device 402 consistent with the present disclosure. In some examples, system 400 can include similar elements as system 300 as referenced in FIG. 3, system 200 as referenced in FIG. 2, and/or system 100 as referenced in FIG. 1. For example, system 400 can include a configuration device 408 that includes a processing resource 412, a power source 416, and a memory resource 414 storing instructions 452, 454, 456, 458, 460. In addition, system 400 can include a device 402 positioned within a device package 404.

As described herein, the configuration device 408 can be coupled to the device 402 through a connection cable 410 that is coupled to a port 420. In some examples, the connection cable 410 can extend through a package gate 406 or aperture within the device package 404. For example, the configuration device 408 can include a connection cable 410 to couple to a port 420 of the computing device 402 when the computing device 402 is positioned within the device packaging 404. In this example, the connection cable 410 can electrically and communicatively couple the configuration device 408 to the computing device 402.

Instructions 452, when executed by a processing resource such as processing resource 412 can provide electrical power to the computing device 402 through the connection cable 410. As described herein, providing electrical power to the computing device 402 can include the configuration device 408 utilizing the power source 416 to provide the electrical power to the computing device 402 through the connection cable 410.

As described herein, the configuration device 408 can determine a device type of the computing device 402 to determine a quantity or type of electrical power to be provided to the computing device 402. For example, a plurality of electrical devices can utilize different voltage, current, or type of current (e.g., direct current, alternating current, etc.) of electrical power. In this example, the configuration device 408 can utilize the device type to determine the properties of the electrical power that the device 402 utilizes and provide the electrical power with the determined properties through the connection cable 410.

Instructions 454, when executed by a processing resource such as processing resource 412 can activate a secure network connection between the computing device 402 positioned within the device packaging 404 and a remote computing device associated with an end user of the computing device 402. As described herein, the computing device 402 can receive the electrical power from the power source 416 and the activation instructions through the port 420. In some examples, the port 420 can be a USB type port such as a USB-C port. In this way, the electrical power and instructions can be provided through the same port 420. In this way, a single connection cable 410 can be utilized to provide electrical power and instructions to the device 402.

In some examples, activating the secure network connection can include the configuration device utilizing the network interface 418 to provide the secure network connection for the computing device 402 through the connection cable 410. In some examples, the secure network connection can include virtual private network (VPN) or other type of secure network connection. In some examples, the network interface 418 can be a network interface that sets up the secure network connection with a remote computing device to allow the remote computing device to communicate with the computing device 402 while the computing device 402 is positioned within the device packaging 404. In this way, the remote computing device can be utilized to configure the computing device 402 from a remote location while the device 402 is positioned within the device package 404.

In some examples, the network interface 418 can be a separate network interface from a network interface utilized by the configuration device 408. For example, the configuration device 408 can utilize a first network interface to utilize for updating the configuration device 408 while a second network interface is utilized to provide the secure network connection for the computing device 402. In this way, the configuration device 408 may not have access to the secure connection between the computing device 402 and the remote computing device configuring the computing device 402. This can increase the security of configuring the computing device 402 since a third party does not have access to the configuration settings and/or format settings of the computing device 402.

Instructions 456, when executed by a processing resource such as processing resource 412 can determine when the remote computing device has applied a format setting to the computing device 402 positioned within the device packaging 404. In some examples, the configuration device 408 can determine when the remote computing device has completed applying the format setting to the computing device 402. For example, the configuration device 408 can receive a message from the remote computing device that the format setting has been applied or installed on the computing device 402. In this way, the configuration device 408 can be notified that the format setting has been applied to the computing device 402.

In some examples, an error may occur if the configuration device 408 either disconnects the secure network connection or disconnects the power provided to the computing device 402 prior to completion of the format setting being applied to the computing device 402. In this way, it can be important for the configuration device 408 to determine when the remote computing device has applied the format setting to the computing device 402 before the configuration device 408 disconnects the secure network connection or disconnects the electrical power provided to the computing device 402.

Instructions 458, when executed by a processing resource such as processing resource 412 can deactivate the secure network connection. In some examples, the configuration device 408 can utilize the network interface 418 to deactivate the secure network connection between the computing device 402 and the remote computing device. In some examples, deactivating the secure network connection can include disabling or disconnecting the secure network connection such that the remote computing device is not able to communicate with the computing device 402.

Instructions 460, when executed by a processing resource such as processing resource 412 can shut down the computing device for transporting to the end user. In some examples, shutting down the computing device 402 (e.g., deactivating the computing device 402, etc.) can include sending a signal or message to the computing device 402 to shut down with a shutdown process associated with the computing device 402. In some examples, shutting down the device 402 can include preventing electrical power from being transferred to the computing device 402 through the connection cable 410.

Once the computing device 402 is deactivated by the configuration device 408, the connection cable 410 can be removed from the device package 404 and the package gate 406 can be closed and locked as described further herein. Once the computing device 402 is shut down and the package gate 406 is closed and locked, the computing device 402 can be shipped to the end user. As described further herein, the package gate can be locked to prevent a third-party user from accessing the computing device 402 without physical damage being performed on the package gate 406 and/or the device package 404. In this way, the end user may be able to physically inspect the package gate 406, device package 404, and/or the computing device 402 to ensure a third party was not altering features of the computing device 402.

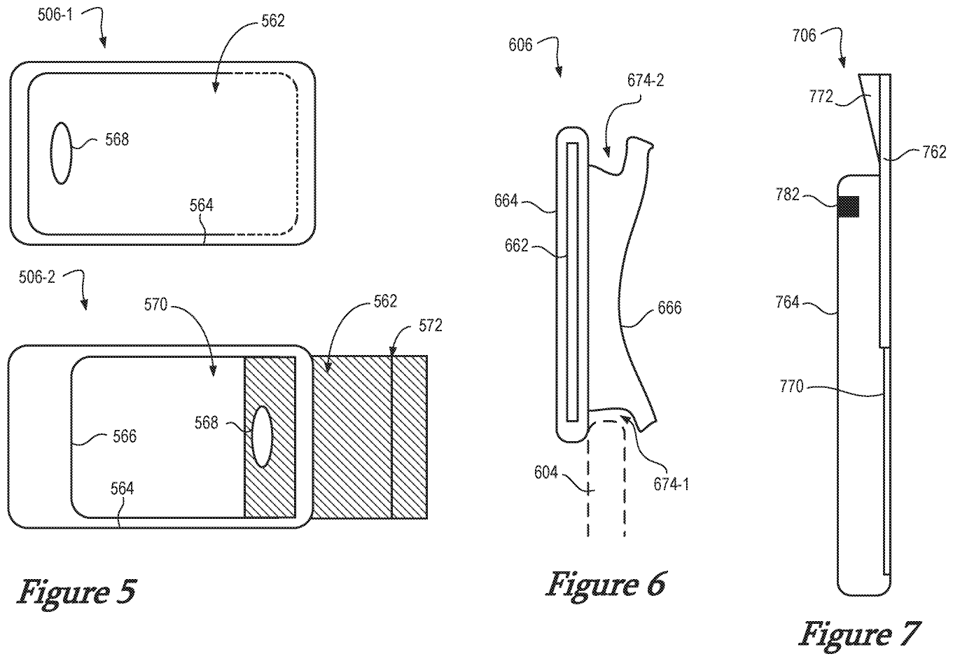

FIG. 5 is an example package gate 506-1, 506-2 consistent with the present disclosure. FIG. 5 illustrates a first state package gate 506-1 and a second state package gate 506-2. As illustrated in FIG. 5. the package gate 506-1, 506-2 can be in an open position in the first state package gate 506-1 and a closed position in the second state package gate 506-2. In some examples, a force can be provided to move the package gate 506-1, 506-2 from the first state package gate 506-1 to the second state package gate 506-2. In some examples, the package gate 506-1, 506-2 can be utilized with the systems described herein, such as system 100 (e.g., package gate 106, etc.).

In some examples, the package gate 506-1, 506-2 can include an insert portion 566 that is insertable into a designated portion of a device package and a gate 562 portion to: expose an aperture 570 in a first state to allow access to the device when the insert portion 566 is inserted into the designated portion of the device package, and seal the aperture 570 in a second state to prevent access to the device when the insert portion 566 is inserted into the designated portion of the device package.

As described further herein, the designated portion can be a portion of the device package that corresponds to an end of a port channel. For example, the designated portion can be a perforated portion of the device package that allows the package gate 506-1, 506-2 to be inserted such that the aperture 570 corresponds to the port channel of the device package to allow access to a port of the device within the device package. As described herein, the port channel includes a path between an exterior portion of the device package and a port of the device within the device package. In some examples, the path of the port channel includes a removed portion of packaging material within the device package to allow access to a particular port of the device within the device package.

In some examples, the package gate 506-1, 506-2 can include a bracket 564 to provide structure to the package gate 506-1, 506-2. In some examples, the bracket 564 can comprise a metallic or polymer type of material that can prevent an aperture 570 from closing in the package gate first state 506-1. In some examples, the bracket 564 can be utilized to define a perimeter of the aperture 570. In some examples, the bracket 564 can house a gate 562 that can expose the aperture 570 in the first state package gate 506-1 and seal the aperture 570 in the package gate second state 506-2. For example, the bracket 564 can include a slot that can receive the gate 562 and allow the gate 562 to slide in a first direction (e.g., to the right as illustrated in FIG. 5) to expose the aperture 570 and/or allow the gate 562 to slide in a second direction (e.g., to the left as illustrated in FIG. 5) to seal the aperture 570.

In some examples, the gate 562 can include a handle 568 to apply force to the gate 562 such that the gate 562 can be moved from a first position to a second position. For example, the handle 568 can allow a user to apply force on the gate 562 to move the gate from an open position as illustrated by the first state package gate 506-1 to a closed position as illustrated by the second state package gate 506-2. In some examples, the handle 568 can be formed of the same material as the gate 562. For example, the gate 562 can be a metallic or polymer like material. In this example, the handle 568 can be formed together with the gate 562 such that the handle 568 and the gate 562 are a single piece of material.

In some examples, the package gate 506-1, 506-2 can include an insert portion 566 that can be inserted into an aperture of the device package. In some examples, the insert portion 566 can be utilized to cut the device package such that an aperture is created in the device package to position the package gate 506-1, 506-2 into the device package. For example, the insert portion 566 can include a cutting edge that can perforate the device package such that the perforated portion of the device package can be removed and the package gate 506-1, 506-2 can be positioned within the device package.

In some examples, the insert portion can include a lipped portion that can be positioned at an interior portion of the device package as described further herein. In some examples, the lipped portion can prevent the package gate 506-1, 506-2 from being removed from the device package without further damaging the device package. In this way, the package gate 506-1, 506-2 can provide an indication that a third party or unwanted user has not accessed the device within the device package.

In some examples, the device package can include a perforated portion at an exterior location to indicate where the package gate 506-1, 506-2 should be inserted such that the aperture 570 aligns with a cable channel. As used herein, the perforated portion of the device package can include a pre-cut portion of the device package that can be more easily removed than a non-perforated portion of the device package. The perforated portion can also be an indicator of the location of a cable channel. As described herein, a cable channel can be a location that has packaging material removed or a tubular structure to prevent the packaging material from impeding or blocking a port of a device within the device packaging. In this way, the package gate 506-1, 506-2 can be inserted into a device package at a location that aligns the aperture 570 with the device channel, such that a connection cable can be fed through the aperture 570 to a device port of the device within the device package.

In some examples, the package gate 506-1, 506-2 can include a lift plate 572. In some examples, the lift plate 572 can include a raised portion of the gate 562. In some examples, the lift plate 572 can include an angular portion that can be slid under a plate stop (not shown), but once the lift plate 572 is beyond the plate stop, the plate stop can prevent the gate from moving. In this way, gate 562 can be moved from an open position as illustrated by the first state package gate 506-1 to a closed position as illustrated by the second state package gate 506-2, but the gate 562 is prevented from moving from the closed position to the open position.

In some examples, the lift plate 572 can allow the package gate 506-1, 506-2 to be a single use package gate. For example, the package gate 506-1, 506-2 can be inserted in the open position, closed once the device within the device package is configured, and the lift plate 572 can ensure that the aperture 570 is sealed from later usage by an unwanted individual. In addition, the lift plate 572 can be utilized to seal the aperture 570 to prevent exterior elements from reaching the interior portion of the device package, which could damage the packaging material and/or the device within the device package. In some examples, the gate 562 portion provides a permanent lock with the lift plate 572 when the package gate 506-2 is in the second state to prevent access to a port channel of the device package.

In some examples, the lift plate 572 can be the same material as the gate 562. For example, the lift plate 572 can be a metallic or polymer material that can be processed with the gate 562 and/or the handle 568. For example, the gate 562, handle 568, and/or lift plate 572 can be molded as a single piece from a polymer like material.

FIG. 6 is an example package gate 606 consistent with the present disclosure. In some examples, the package gate 606 can be a side view of the package gate 506-1, 506-2 as referenced in FIG. 5. In addition, the package gate 606 can be utilized with the systems described herein to allow access (e.g., one-time access, etc.) to a port channel of the device package 604 to access a port of the device within the device package 604. In some examples, the package gate 606 can include the same elements or features as the package gate 506-1, 506-2 illustrated in FIG. 5. For example, the package gate 606 can include an insert portion 666, a bracket 664, and/or a gate 662.

In some examples, the device package 604 can be an enclosure utilized to ship or store a device positioned within the device package 604. For example, the device package 604 can be a cardboard enclosure that can prevent exterior materials (e.g., dust, debris, water, etc.) from reaching the device. In some examples, the exterior materials can damage the device within the device package 604. In some examples, the device package 604 includes a designated area positioned at an exterior position of the device package 604. In these examples, the designated area can be a marked area or perforated area that designates a location of a port channel. In some examples, the designated area can be an area of the device package 604 where packaging material can be removed from the interior of the device package 604 to access the port of the device. That is, the package gate 606 can allow packaging material to be removed from within the device package 604 when the package gate 606 is inserted at the designated area.

In some examples, the device package 604 can include a port channel positioned between the designated area and a port of a device within the device package 604. In these examples, the device package 604 can include the package gate 606 positioned within an aperture at the designated area. In these examples, the package gate 606 can include an exposed state to allow access to the port channel and a sealed state to prevent access to the port channel. In some examples, the exposed state can be a state when the gate 662 is in the open position and the sealed state can be a state when the gate 662 is in a closed position or sealed position.

As described herein, the package gate 606 can include an insert portion 666. In some examples, the insert portion 666 can include a lip and an indent 674-1, 674-2. In some examples, the insert portion 666 and/or the indent 674-1, 674-2 can surround an exterior of the package gate 606 such that the indent 674-1, 674-2 is able to receive an edge of the device package 604 aperture. For example, the package gate 606 can be inserted into the aperture of the device package 604 and the edges of the device package 604 can be inserted into the indent 674-1, 674-2 to prevent the package gate 606 from being removed from the device package 604 without damaging the package gate 606 and/or the device package 604.

In some examples, the insert portion 666 can be made of a flexible material that can flex when the package gate 606 is inserted into the aperture of the device package 604. In this way, the edge of the aperture of the device package 604 may not be damaged while inserting the package gate 606 into the aperture of the device package. In some examples, the material of the insert portion 666 can be different than the material of the gate 662 and/or the bracket 664. That is, the gate 662 and/or the bracket 664 can be made of a relatively less flexible material. In this way, the bracket 664 and/or gate 662 can provide protection from exterior materials such as debris from entering the port channel.

FIG. 7 is an example package gate 706 consistent with the present disclosure. In some examples, the package gate 706 can be a side view of the package gate 506-1, 506-2 as referenced in FIG. 5 and/or package gate 606 as illustrated in FIG. 6. In addition, the package gate 706 can be utilized with the systems described herein to allow access (e.g., one-time access, etc.) to a port channel of the device package to access a port of the device within the device package. In some examples, the package gate 706 can include the same elements or features as the package gate 506-1, 506-2 illustrated in FIG. 5 and/or package gate 606 as illustrated in FIG. 6. For example, the package gate 706 can include an insert portion, a bracket 764, a lift plate 772, an aperture 770, and/or a gate 762.

In some examples, the package gate 706 includes a locking mechanism that allows the package gate 706 to move from the first state or open state to the second state or closed state a single time. In some examples, the locking mechanism can include a lift plate 772 that interacts with a plate stop 782. FIG. 7 illustrates how the lift plate 772 can interact with a plate stop 782 to allow the package gate 706 to only move from the first state to the second state a single time without damaging the package gate 706 or the device package. For example, the gate 762 can be moved from an open position illustrated in FIG. 7 to a closed position. In this example, the gate 762 can be moved with a force to the left as illustrated in FIG. 7 to seal the aperture 770. As described herein, the lift plate 772 can be an angled raised portion to allow the lift plate 772 to move under the plate stop 782 with a force. In some examples, once the lift plate 772 has completely passed the lift stop 782 the highest point of the lift plate 772 can be prevented from moving to the open position or to the right as illustrated in FIG. 7. In this way, the package gate 706 engages a permanent self-locking mechanism (e.g., lift plate 772 and plate stop 782, etc.) when put into the sealed state.

In some examples, the lift plate 772 can be formed as part of the gate 762 such that the aperture 770 is permanently or semi-permanently sealed such that the gate 762 is not moveable to the open position once the gate 762 is in the closed position. This can prevent a third-party user or unwanted user from accessing the aperture 770 without damaging the package gate 762 and/or the device package.

In some examples, the lift plate 772 can be an actuated element that is a loaded device (e.g., spring loaded device, etc.) that can be actuated to a raised position when the lift plate 772 moves past the plate stop 782. For example, the lift plate 772 can be spring loaded material that can apply a force in an upward direction as illustrated in FIG. 7 such that a force is applied in a downward direction as illustrated in FIG. 7 to pass the lift plate 772 under the plate stop 782 and once the lift plate 772 completely passes the plate stop 782 the spring force can move in the upward direction to prevent the lift plate 772 from moving toward the open position.

In some examples, the package gate 706 can include an indicator to display when the package gate 706 has been in the first state (e.g., open state, etc.) and the second state closed state, etc.). In some examples, the indicator can be coupled to the lift plate 772 and protrude through the bracket 764 to indicate to a user that the gate 762 has been moved from the first state to the second state. In some examples, the indicator can be utilized to notify an end user that the port channel was previously sealed or positioned in the second state after a configuration process. In some examples, the indicator can be a tab positioned on the lift plate 772 that protrude through the bracket 764 when the lift plate 772 extends in the upward direction as illustrated in FIG. 7. In some examples, the bracket 764 can include a tab aperture to receive the indicator tab when the lift plate 772 extends in the upward direction as described herein.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. Further, as used herein, “a number of” an element and/or feature can refer to any number of such elements and/or features.

What is claimed:

1. A configuration device, comprising:
a connection cable to be coupled to a port of a device positioned within a device package, wherein the connection cable is to provide electrical power to the device positioned within the device package and provide communication between the configuration device and the device positioned within the device package; and
a computing device comprising instructions to:
activate the device positioned within the device package through the connection cable;
format the device positioned within the device package through the connection cable; and
deactivate the device positioned within the device package through the connection cable.

2. The configuration device of claim 1, wherein the instructions to format the device include instructions to alter configuration settings of the device based on an end user of the device positioned within the device package.

3. The configuration device of claim 1, comprising a power source to provide the electrical power to the device positioned within the device package through the connection cable.

4. The configuration device of claim 1, wherein the port of the device positioned within the device packaging is the only port accessible to an exterior position of the device package.

5. The configuration device of claim 1, wherein the computing device includes instructions to store format settings for a plurality of different devices and to apply a corresponding format setting to the device within the device packaging based on an identification of the device within the device packaging.

6. A system, comprising:
a device;
a device packaging to enclose the device for transport from a manufacturer to an end user; and
a configuration device, comprising:
a connection cable to couple to a port of the device when the device is positioned within the device packaging;
a power supply to transfer electrical power through the connection cable; and
a memory resource storing instructions executable by a processor to:
determine a format setting for the device within the device packaging based on an identification associated with the device;
provide electrical power to the device through the connection cable with the power supply;
activate the device through the connection cable; and
apply the format setting to the device through the connection cable.

7. The system of claim 6, wherein the instructions to activate the device include instructions to activate a configuration mode of the device to enable the device to receive the format setting.

8. The system of claim 6, comprising instructions to activate a secure network connection for the device through the connection cable.

9. The system of claim 8, wherein the secure network connection is utilized to alter configuration settings of the device from a remote location when the device is positioned within the device packaging.

10. The system of claim 6, wherein the instructions to determine the format settings for the device include instructions to determine a profile of an end user for the device.

11. The system of claim 6, wherein the format setting is applied to a drive of the device.

12. A system comprising:
a computing device;
a device packaging to enclose the computing device for transport from a manufacturer to an end user; and
a configuration device, comprising:
a connection cable to couple to a port of the computing device when the computing device is positioned within the device packaging, wherein the connection cable electrically and communicatively couples the configuration device to the computing device; and
a memory resource storing instructions executable by a processor to:
provide electrical power to the computing device through the connection cable;
activate a secure network connection between the computing device positioned within the device packaging and a remote computing device associated with an end user of the computing device;
determine when the remote computing device has applied a format setting to the computing device positioned within the device packaging;
deactivate the secure network connection; and
shut down the computing device for transporting to the end user.

13. The system of claim 12, wherein the connection cable is positioned within a cable channel of the device packaging to couple to the port of the device.

14. The system of claim 12, wherein the secure network connection is provided through the connection cable.

15. The system of claim 12, wherein the configuration device includes a plurality of connection cables to couple to a plurality of different computing devices positioned within corresponding device packages simultaneously.
